(19) United States
(12) Patent Application Publication
(10) Pub. No.: US 2024/0326825 A1
(43) Pub. Date: Oct. 3, 2024

(54) AUTONOMOUS VEHICLE FEEDBACK SYSTEM AND METHOD OF OPERATING AN AUTONOMOUS VEHICLE

(71) Applicant: Toyota Motor Engineering & Manufacturing North America, Inc., Plano, TX (US)

(72) Inventors: Frederico Marcolino Quintao Severgnini, Ann Arbor, MI (US); Sean P. Rodrigues, Ann Arbor, MI (US); Ercan Dede, Ann Arbor, MI (US)

(21) Appl. No.: 18/193,972

(22) Filed: Mar. 31, 2023

(51) Int. Cl. B60W 40/08; B60W 60/00; G06Q 30/0251; G06V 20/59; G06V 40/16

(52) U.S. Cl. CPC B60W 40/08; B60W 60/00; G06Q 30/0265; G06V 20/597; G06V 40/16; B60W 2050/0075; B60W 2540/22; B60W 2540/221

(57) ABSTRACT

An autonomous vehicle feedback system includes at least one sensor embedded in an interior surface of a vehicle and a processor electrically coupled to the at least one sensor. The processor establishes a baseline for a physiological parameter of an occupant of the vehicle based on feedback from the at least one sensor, and provides an adjustment to at least one of a plurality of vehicle operations when a deviation of the physiological parameter compared to the baseline. The adjustment of the at least one of the plurality of vehicle operations is proportional to the deviation of the physiological parameter from the baseline.

### TECHNICAL FIELD

The present specification generally relates to vehicle feedback systems and, more specifically, autonomous vehicle feedback systems and methods of operating an autonomous vehicle.

### BACKGROUND

Autonomous vehicles have become increasingly prevalent in modern transportation systems. These vehicles are designed to operate without the need for a human operator and rely on a variety of sensors and processors to navigate and make decisions. While autonomous vehicles offer numerous benefits, such as increased safety and efficiency, automated adjustments to vehicle operations may induce high levels of stress and/or anxiety in an occupant of the vehicle. For example, sudden changes to the vehicle's speed and/or acceleration may cause the occupant of the vehicle to become stressed. Accordingly, there is a need for a feedback system that can determine an emotional state of the occupant of the vehicle in real-time in order to ensure that a safe and relaxing driving experience is achieved.

### SUMMARY

In one embodiment, an autonomous vehicle feedback system is disclosed. The feedback system includes at least one sensor embedded in a interior surface of a vehicle and a processor electrically coupled to the at least one sensor. The processor establishes a baseline for a physiological parameter of an occupant of the vehicle based on feedback from the at least one sensor, and provides an adjustment to at least one of a plurality of vehicle operations when a deviation of the physiological parameter compared to the baseline. The adjustment of the at least one of the plurality of vehicle operations is proportional to the deviation of the physiological parameter from the baseline.

In another embodiment, another autonomous vehicle feedback system is disclosed. The feedback system may include a light diffuser embedded in an interior surface of a vehicle, and at least one optical sensor embedded in the interior surface of the vehicle. A processor may be electrically coupled to the at least one optical sensor. The optical sensor monitors a refractive light index generated by the light diffuser and the processor establishes a baseline moisture level of an occupant of the vehicle based on the refractive light index measured by the at least one optical sensor. The processor provides an adjustment to at least one of a plurality of vehicle operations when a deviation from the baseline moisture level occurs, such that the adjustment of the at least one of the plurality of vehicle operations is proportional to the deviation of from the baseline moisture level.

In yet another embodiment, a method of operating an autonomous vehicle is disclosed. The method may involve monitoring a physiological parameter of an occupant of a vehicle using at least one sensor embedded in an interior surface of the vehicle. The method may further involve establishing a baseline for the physiological parameter of the occupant of the vehicle based on feedback from the at least one sensor. Once the baseline is established, the method may involve providing an adjustment to at least one of a plurality of vehicle operations operation when a deviation of the physiological parameter from the baseline is measured by the at least one sensor, such that the adjustment of the at least one of the plurality of vehicle operations is proportional to the deviation of the physiological parameter from the baseline.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an operating environment in which various aspects of an autonomous vehicle feedback system may be implemented, according to one or more embodiments shown and described herein;

FIG. 2 is a perspective view of an inside of a vehicle including the autonomous vehicle feedback system of FIG. 1, according to one or more embodiments shown and described herein;

FIG. 3 is a front view of a steering wheel of the autonomous vehicle feedback system of FIG. 1, according to one or more embodiments shown and described herein;

FIG. 4 is front view of the steering wheel of FIG. 3 being engaged by a driver of a vehicle, according to one or more embodiments shown and described herein; and

FIG. 5 is an illustrative flow diagram of a method of operating an autonomous vehicle, according to one or more embodiments shown and described herein.

### DETAILED DESCRIPTION

Embodiments described herein are generally directed to autonomous vehicle feedback systems and methods of operating an autonomous vehicle. The autonomous vehicle feedback system may include a camera for determining the emotional response of an occupant of the vehicle to changes in operation of the vehicle, and at least one sensor embedded in an interior surface, such as a steering wheel, of the vehicle that may be configured to determine the magnitude of the emotional response of the occupant. Operation of the vehicle may then be automatically adjusted based on the magnitude of the emotional response of the occupant.

The autonomous vehicle feedback systems described herein may utilize a camera positioned within an interior of a vehicle to determine the emotional response (e.g., happy, sad, neutral, etc.) of the occupant of the vehicle, such as a driver. As the autonomous vehicle operates, the camera may further monitor the occupant to determine the occurrence of changes to the emotional response of the occupant which may stem from automated changes to at least one of a plurality of vehicle operations.

Although many vehicle feedback systems may adjust the at least one of the plurality of vehicle operations based on the emotional response of the driver, these systems are unable to ensure a comfortable and stress-free driving experience. For example, a standard vehicle feedback system may engage a braking system of the vehicle when the system determines that the driver has had a negative response to an automated increase in a speed of the vehicle. However, simply adjusting at least one of the plurality of vehicle operations based on the emotional response (e.g., negative response) of the driver fails to ensure that the negative emotional response is immediately remedied. For instance, although the feedback system may engage the braking system of the vehicle when a driver has a negative response to an increase in the speed of the vehicle, the feedback system may not sufficiently decrease the speed of the vehicle in order to return the driver to a neutral and/or happy emotional state.

As provided herein, the term “autonomous” may be defined as a device (e.g., vehicle, etc.) capable of operating without direct user control. For the purposes of the present disclosure, it should be understood that the term “autonomous” may encompass a vehicle having any level of autonomy. For example, the term “autonomous” may encompass a fully autonomous (e.g., self-driving) vehicle or a similar vehicle with minimal autonomy (e.g. a vehicle with cruise control, etc.)

The autonomous vehicle feedback systems described herein may remedy these issues by further utilizing a diffuser, such as a light diffuser, and a plurality of sensors to determine a magnitude of the emotional response of the driver. For example, once the camera has determined the general emotional response of the occupant of the vehicle (e.g., happy, sad, neutral, etc.), the diffuser and the plurality of sensors may track a physiological parameter of the occupant to determine the magnitude of the emotional response of the user. In these embodiments, the magnitude of the emotional response may be determined by tracking variation of the physiological parameter from an established baseline parameter. By determining the magnitude of the emotional response in addition to the general emotional response, the autonomous vehicle feedback system may ensure that the change in the at least one of the plurality of vehicle operations is proportional to the magnitude of the emotional response of the occupant of the vehicle, thereby ensuring a comfortable and enjoyable driving experience.

Various embodiments of autonomous vehicle feedback system and methods of operating autonomous vehicles will now be described herein. Whenever possible, the same reference numerals will be used throughout the drawings to refer to the same or like parts.

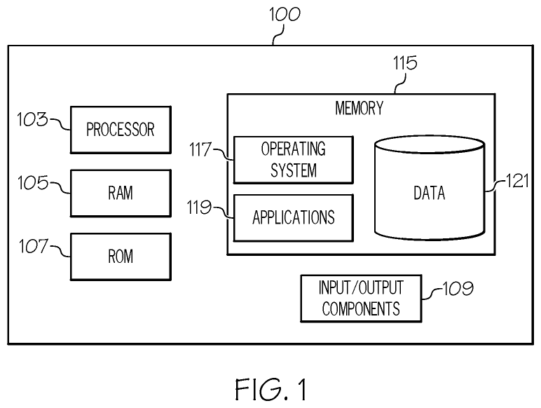

Referring now to FIG. 1, an operating environment for an autonomous vehicle feedback system 100 is depicted. As depicted in the example embodiment of FIG. 1, the feedback system 100 may collect critical driving data and other physiological data related to an occupant of the vehicle, process the data in real-time, and adjust at least one of a plurality of vehicle operations based on the physiological data of the occupant. In these embodiments, the feedback system 100 may have a processor 103 for controlling overall operation of the feedback system 100 and its associated components, which may include RAM 105, ROM 107, input/output component 109, and memory 115, as will be described in additional detail herein. Furthermore, it should be noted that the feedback system 100 may be powered by a battery or by the vehicle's electrical system. The feedback system 100 may also include a charging port or a wireless charging system to allow the battery to be recharged if necessary.

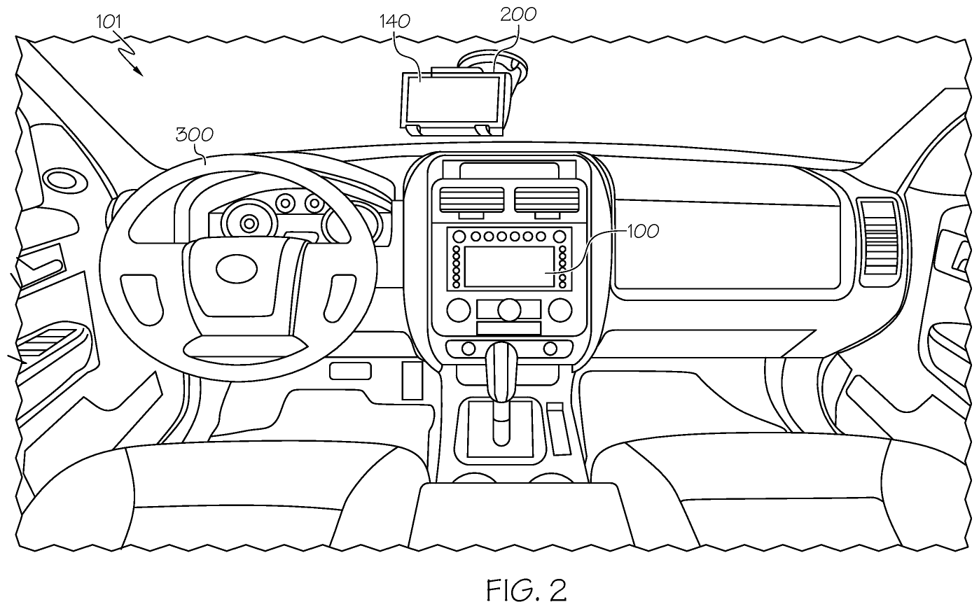

In these embodiments, the I/O 109 may include at least one data collection device, such as a microphone, keypad, touch screen, camera, or other sensor which may obtain physiological data related to the occupant of the vehicle, and may also include one or more of a speaker for providing audio output and a video display device or graphical user interface for providing textual, audiovisual and/or graphical output. The various I/O components 109 may be described in additional detail herein in reference to FIG. 2-4.

Referring still to FIG. 1, the I/O 109 may be connected via hardwire connections, such as USB, serial cables, parallel cables, etc. The I/O 109 may also be connected via wireless connections, such as Bluetooth, cellular technology, or other similar technologies. Software or applications may be stored within memory 115 and/or storage to provide instructions to processor 103 for enabling the feedback system 100 to perform various functions. For example, the memory 115 may store software used by the feedback system 100, such as an operating system 117, application programs 119, and an associated database 121. The processor 103 and its associated components may allow the feedback system 100 to run a series of computer-readable instructions to generate a drive summary for an occupant of the vehicle and analyze the driving data, emotional responses, and physiological data of the occupant of the vehicle during the drive. The processor 103 may further allow the feedback system 100 to adjust the at least one the plurality of vehicle operations in response to emotional response and physiological data obtained by the I/O components 109. Additionally, the application program 119 used by the feedback system 100 according to an illustrative embodiment of the disclosure may include computer executable instructions for invoking functionality related to receiving, verifying, determining, and analyzing the driving data and physiological data of the driver.

Turning now to FIG. 2, the vehicle feedback system 100 may be mounted to an interior surface of a vehicle 101, so that the driver of the vehicle 101 can see the feedback system 100 while driving. For example, the feedback system 100 may be mounted anywhere in the vehicle 101, such as on a steering wheel, 102, a windshield, on a dashboard, on a driver's side window, an armrest of the vehicle, or any other similar interior surface of the vehicle. The feedback system 100 may also be a component or display screen integrated into or on the vehicle dashboard, as illustrated at reference number 100A. In these embodiments, the feedback system 100 may display visual representations related to the physiological data obtained by the I/O components 109 so that the occupant of the vehicle is aware of their emotional response to automated changes in any of the plurality of vehicle operations during a drive.

As has been described herein, the feedback system 100 may include a graphical user interface 140, a processor 103, and at least one data collection device. In the embodiment depicted in FIG. 2, the at least one data collection device may include a plurality of data collection devices, such as a camera 200 and a physiological data detection assembly 300 embedded in steering wheel 102 of the vehicle 101. However, it should be appreciated that the feedback system 100 of FIG. 2 is for illustrative purposes only, and the feedback system 100 may be incorporated into any of the interior surfaces of the vehicle 101 described herein. For example, in some embodiments, the vehicle 101 may be an autonomous vehicle, such that the vehicle 101 may move the steering wheel 102 to a folded position while the vehicle 101 is in a driving mode. Further still in some embodiments, the vehicle 101 may not include a steering wheel 102. In these embodiments, it should be understood that the feedback system 100 may necessarily be incorporated into another surface of the interior surfaces of the vehicle 101 described herein.

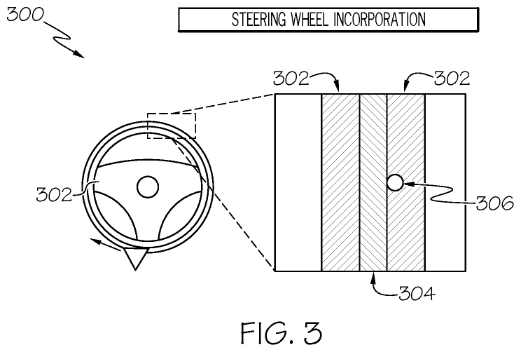

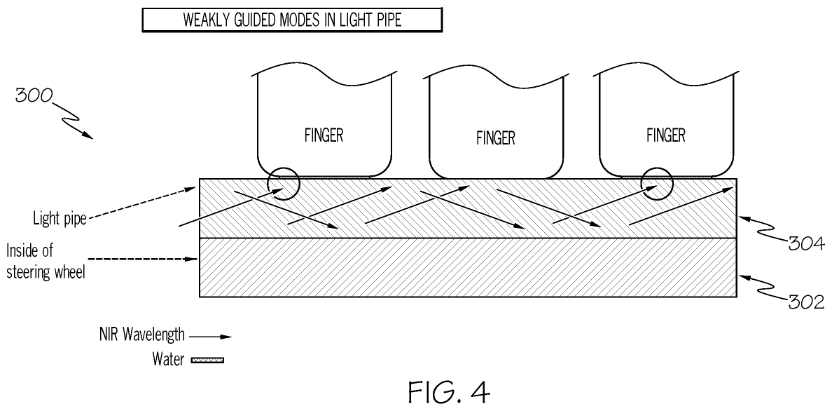

Referring still to FIG. 2, the camera 200 may be configured to determine an emotional response of the occupant of the vehicle as any of the plurality of vehicle operations are adjusted during a drive. Furthermore, the physiological data detection assembly 300 may be configured to determine the magnitude of the emotional response captured by the camera 200, as will be described in additional detail herein with reference to FIGS. 3 and 4. In these embodiments, the processor 103 may be electrically coupled to both the camera 200 and the physiological data detection assembly 300, such that the processor 103 may adjust at least one of a plurality of vehicle operations in response to the physiological data obtained by the camera 200 and the physiological data detection assembly 300.

In these embodiments, the graphical user interface 140 may be used to communicate vehicle operation and the occupant's emotional response to the vehicle operation. To effectively communicate with the occupant of the vehicle, the graphical user interface 140 may be located in a convenient location within the vehicle 101, such as on the dashboard or in the center console. The graphical user interface 140 can show the occupant of the vehicle 101 changes to the plurality of vehicle operations in real-time, and further communicate to the occupant the magnitude of the emotional response the occupant is having to the changes in the plurality of vehicle operations. Furthermore, the graphical user interface 140 may communicate any changes being made to the operation of the vehicle 101 so that the occupant is aware of the changes before they occur. In these embodiments, if the occupant of the vehicle 101 does not wish the feedback system 100 to alter the operation of the vehicle, the occupant may manually cancel the proposed adjustment to the vehicle operation. Furthermore, it should be noted that, in some embodiments, the graphical user interface 140 is optional.

Accordingly, the feedback system 100 may also include user input controls, such as buttons or a touch screen, that allow the occupant of the vehicle to manually adjust the vehicle operation or override the changes made by the feedback system 100. This can be useful in cases where the occupant wishes to override the adjustments initiated by the feedback system 100 or if the feedback system 100 is unable to accurately determine the emotional response of the occupant, as will be described in more detail herein.

As further illustrated in FIG. 2, the camera 200 may be mounted in the vehicle 101 and positioned to capture a clear view of the face of the occupant of the vehicle 101. In these embodiments, the camera 200 may be mounted anywhere in the vehicle 101, such as on the windshield, on the dashboard, on the driver's window, or any other location that allows for a clear view of the occupant's face. Furthermore, it should be noted that the camera 200 may be integrated into the graphical user interface 140 of the feedback system 100, as depicted in FIG. 2, or otherwise integrated into the vehicle 101.

In these embodiments, the camera 200 may use image recognition technology, such as facial recognition technology, to analyze the facial expressions of an occupant and determine an emotional response of the occupant based on the analyzed facial expressions. For example, the camera 200 may be used to determine if changes to the at least one of the plurality of vehicle operations cause a happy, sad, or neutral emotional response from the occupant of the vehicle 101.

In the embodiments described herein, the plurality of vehicle operations may include a vehicle speed, route, driving mode, temperature, airflow, audio content, and message display or notification, or any similar vehicle operation that may be autonomously adjusted by the feedback system 100 during the course of a drive. For example, the feedback system 100 may automatically adjust the speed of the vehicle 101 during a drive based on traffic conditions and/or other route simulations. As the vehicle speed is adjusted, the camera 200 may continuously monitor the face of the occupant of the vehicle 101 to determine the emotional response of the occupant. For instance, as the speed of the vehicle 101 increases, the occupant may frown or give other similar signs of stress and/or discomfort. Thus, the camera 200 may indicate that the occupant has had a negative emotional response to the increased speed of the vehicle 101, at which point the feedback system 100 may adjust the speed of the vehicle 101 to comfort the occupant.

As has been discussed herein, the feedback system 100 may not adjust at least one of the plurality of vehicle operations based solely on the emotional response determined by the camera 200; instead, the feedback system 100 may further determine the magnitude of the emotional response to determine the degree to which the at least one of the plurality of vehicle operations should be adjusted.

To determine the magnitude of the emotional response of the occupant of the vehicle, the feedback system 100 may further utilize the physiological data detection assembly 300, as depicted in FIG. 3. In these embodiments, the physiological data detection assembly 300 may be integrated into the steering wheel 302 of the vehicle, such that the physiological data detection assembly 300 is capable of detecting a physiological parameter of the occupant of the vehicle. The physiological parameter may be any physiological parameter that may be used to determine the magnitude of the emotional response of the vehicle occupant, including moisture level of the skin (e.g., perspiration), heart rate, respiration rate, body temperature, brain activity, or any similar parameter.

Although the physiological data detection assembly 300 illustrated herein is depicted as being embedded in a steering wheel of a vehicle, it should be understood that the physiological data detection assembly 300 may be positioned at any location within the vehicle without departing from the scope of the present disclosure. For example, in embodiments in which the vehicle is a fully autonomous vehicle, the vehicle may not be equipped with a steering wheel. Accordingly, in these embodiments, the physiological data detection assembly 300 may be integrated into a dashboard, a mirror, a seat, an armrest, or any other similar component of the vehicle without departing from the scope of the present disclosure.

In the embodiment depicted in FIG. 3, the physiological parameter measured by the physiological data detection assembly 300 may be the moisture level of the skin of the occupant of the vehicle. In these embodiments, the physiological data detection assembly 300 may monitor changes in the moisture level of the skin of the occupant of the vehicle 101 to gauge the magnitude of the occupant's emotional response as the at least one of the plurality of vehicle operations are adjusted by the feedback system 100.

To measure the moisture level of the skin of the occupant of the vehicle, the physiological data detection assembly 300 may include a light diffuser 304, such as a light pipe or a waveguide, and at least one sensor 306, such as an optical sensor. In these embodiments, the light diffuser 304 may be embedded within the steering wheel 302 of the vehicle, such that the light diffuser 304 may come into contact with the hands of an occupant when the occupant is holding the steering wheel 302. The light diffuser 304 may include a transparent or translucent material that allows for the passage of light between the light diffuser 304 and the hands of the vehicle occupant.

Referring now to FIGS. 3 and 4, the at least one sensor 306 is located on the steering wheel 302 and is used to measure the refractive index of the light that passes through the light diffuser 304. The refractive index of light is a measure of how much the light is bent as it passes through the light diffuser 304, which is affected by the moisture content present on the light diffuser 304, and in turn, the hands of the occupant of the vehicle. For example, when the moisture content on the light diffuser 304 increases, the refractive index of light passing through the light diffuser 304 also increases. Similarly, when the moisture content on the light diffuser 304 decreases, the refractive index of light passing through the light diffuser 304 also decreases.

In order to determine the magnitude of the emotional response of the occupant of the vehicle, the physiological data detection assembly 300 may establish a baseline for the physiological parameter and continuously measure the physiological parameter to determine when variations from the baseline occur. In these embodiments, the variations of the physiological parameter may correspond to the intensity (e.g., magnitude) of the emotional response of the occupant of the vehicle. For example, when the at least one sensor 306 measures a significant variation of the physiological parameter from the established baseline, this may indicate that the occupant of the vehicle has suffered an intense emotional response to changes in the vehicle operation. Conversely, minimal deviations from the baseline may indicate negligible emotional responses.

In these embodiments, the baseline physiological parameter may be established in a variety of ways. For example, the physiological data detection assembly 300 may monitor the physiological parameter for a predetermined period of time necessary to establish the baseline for the physiological parameter. In these embodiments, a new baseline for the physiological parameter may be generated each time a vehicle occupant utilizes the vehicle. In other embodiments, once the baseline for the physiological parameter is determined, the occupant of the vehicle may save the baseline to a user profile, which may be stored within the memory 115 of the feedback system 100. Accordingly, each time the vehicle occupant utilizes the vehicle, the baseline of the physiological parameter associated with the particular user profile may be loaded to the feedback system 100, and variations of the physiological parameter may be determined based on the stored baseline.

Referring collectively to FIGS. 1-4, once the baseline physiological parameter has been established, the feedback system 100 may utilize the at least one sensor 306 to continuously measure the refractive index of light passing through the light diffuser 304 and compare the measured physiological parameter to the baseline. When the measured refractive index exceeds the baseline, the feedback system 100 may determine that the vehicle occupant is exhibiting an intense response to automated changes in the vehicle operation, and may adjust at least one of the plurality of vehicle operations accordingly.

For example, during a drive, the feedback system 100 may automatically adjust the driving mode of the vehicle to a more aggressive or sporty setting. As the driving mode adjusts, the at least one sensor 306 may measures a significant increase in the refractive index of light passing through the light diffuser 304, which may suggest that the moisture level on the occupant's hands (e.g., perspiration) has increased. In these embodiments, the feedback system 100 may conclude that the occupant is experiencing an intense emotional response to the changes in the driving mode and adjust the driving mode accordingly.

On the other hand, if the at least one sensor 306 measures a minimal or no change in the refractive index of light passing through the light diffuser 304, the feedback system may confirm that the occupant of the vehicle 101 is not responding intensely to the changes in the driving mode, which may indicate that the occupant of the vehicle 101 is comfortable and no additional changes to the driving mode are necessary.

It should be further understood that, in these embodiments, the adjustment of the at least one of the plurality of vehicle operations may be proportional in scope to the magnitude of the emotional response of the occupant of the vehicle. For example, the at least one sensor 306 may measure a variety of changes in the refractive index of light passing through the light diffuser 304 as the speed of the vehicle 101 increases, which may correspond to the intensity of the emotional response of the occupant of the vehicle 101, as has been described herein. In these embodiments, when a minimal change in the refractive index of light passing through the light diffuser 304 is measured, the feedback system 100 may minimally adjust the speed of the vehicle 101 in order to return the occupant of the vehicle to a comfortable emotional state. In contrast, in the event a significant change in the refractive index of light passing through the light diffuser 304 is measured, the feedback system 100 may significantly adjust the speed, or potentially stop the vehicle 101, in order to manage the emotional response of the occupant of the vehicle 101.

Furthermore, because the physiological data detection assembly 300 continuously measures the physiological parameter of the occupant in real-time, it should be understood that the feedback system 100 may continuously adjust the plurality of vehicle operations in real-time in order to ensure that the occupant of the vehicle 101 remains comfortable and at ease while in the vehicle 101. In some embodiments, this may involve simultaneously adjusting multiple vehicle operations in order to relax the occupant of the vehicle. For example, in the event an intense negative emotional response is measured by the feedback system 100 in response to an increase in the speed of the vehicle 101, the feedback system 100 may decrease the speed of the vehicle 101, increase the airflow within the vehicle 101, and decrease the temperature within the vehicle 101 simultaneously in an effort to help the occupant of the vehicle relax more quickly.

In these embodiments, the feedback system 100 may store the emotional responses of the occupant and the intensity of the emotional responses relating to changes in each of the plurality of vehicle operations as part of a user profile stored in memory 115. This may allow the feedback system 100 to track the changes in vehicle operation that are associated with particularly positive and/or negative emotional responses for a particular occupant of the vehicle 101. For example, a particular occupant of the vehicle 101 may respond positively to decreases in temperature within the vehicle 101, while other occupants may instead respond positively to increases in temperature within the vehicle 101. By tracking the emotional responses of a particular vehicle occupant in a user profile stored in the memory 115, the feedback system 100 may be configured to adjust the operation of the vehicle to suit the particular occupant when deviations in the physiological parameter are measured.

In some embodiments (not depicted), the feedback system 100 may also be configured to communicate with other systems and/or devices outside of the vehicle, such as traffic control systems and/or emergency services. In these embodiments, if the physiological parameter measured by the at least one sensor deviates too significantly from the baseline (e.g., indicating a high level of stress and/or anxiety), the feedback system may transmit a message to emergency services or to a designated emergency contact to request assistance.

Referring again to FIGS. 1-4, it should be further noted that changes to the physiological parameter of the occupant of the vehicle 101 may be measured in response to advertisements rather than in response to changes in the operation of the vehicle 101. In these embodiments, advertisements may be displayed on the graphical user interface 140 within the vehicle 101. As different advertisements are displayed, the physiological data detection assembly 300 and the camera 200 may work together to determine the nature and the intensity of the occupant's emotional response to each advertisement. These emotional responses may be collected and stored via the memory 115 and analyzed using the processor 103 in order to generate a user profile for the occupant of the vehicle. For example, the feedback system 100 may show the occupant of the vehicle a series of advertisements similar to those that have previously elicited a positive and/or intensely positive response from the occupant, while neglecting advertisements similar to those that have previously elicited a negative and/or intensely negative emotional response.

Referring still to FIGS. 1-4, and as should be appreciated in view of the foregoing, operation of the physiological data detection may be dependent on the vehicle occupant keeping their hands engaged with the steering wheel 302. For example, if the vehicle occupant removes their hands from the steering wheel 302, the data obtained by the at least one sensor 306 embedded in the steering wheel 302 may be unable to accurately measure the physiological parameter of the occupant. This may result in the processor 103 being unable to monitor deviations in the physiological parameter, which may affect the ability of the feedback system 100 to adjust the vehicle's operations to suit the occupant.

To address this issue, the feedback system 100 may include additional sensors or mechanisms to detect when the occupant has removed their hands from the steering wheel 302. When the feedback system 100 detects that the occupant has removed their hands from the steering wheel 302, it may take appropriate action to ensure the proper operation of the vehicle 101. This could include disengaging an autonomous driving mode and transitioning control of the vehicle 101 to the occupant, slowing down the vehicle 101 or activating hazard lights of the vehicle 101. Similarly, the feedback system 100 may display a warning on the graphical user interface 140 that indicates a change to the operation of the vehicle may occur in the event the occupant does not return their hands to the steering wheel 302.

Referring still to FIGS. 1-4, similar issues may arise in instances when multiple vehicle occupants place their hands on the steering wheel 302 simultaneously. For example, if multiple occupants put their hands on the steering wheel 302, the at least one sensor 306 embedded in the steering wheel 302 may measure the physiological parameter associated with multiple occupants at the same time. This could result in the processor 103 being unable to accurately monitor deviations in the physiological parameter, as it may be receiving conflicting or inconsistent data from the at least one sensor 306

To address this issue, the feedback system may further include additional sensors or mechanisms to differentiate between multiple occupants touching the steering wheel 302. For example, the feedback system 100 may include additional sensors in the seat or other areas of the vehicle to detect the presence and physiological state of multiple people, or it may utilize other input methods, such as voice recognition, to differentiate between multiple people. Alternatively, the feedback system 100 may be configured to prioritize the data from one occupant over others. For example, the feedback system may be programmed to prioritize the physiological parameters measured from the driver over other passengers, or to prioritize data from the occupant whose hands are closest to the at least one sensor 306.

It is important to note that the autonomous vehicle feedback system 100 described herein is an example system that can be used to monitor emotional responses of the occupant of the vehicle and adjust the vehicle's operations accordingly. As has been described herein, a variety of other sensors and input methods may be used to measure physiological parameters and a wide variety of vehicle operations may be adjusted in response without departing from the scope of the present disclosure.

For example, in addition to the moisture level of the skin, other physiological parameters that could be measured include heart rate, respiration rate, body temperature, or brain activity. Sensors such as heart rate monitors, temperature sensors, or electroencephalography (EEG) sensors could be used to measure these physiological parameters.

Furthermore, in addition to adjusting the vehicle's speed or route, the feedback system may adjust other aspects of the vehicle's operations in response to deviations in the physiological parameter. For example, the feedback system could adjust the level of automation or the level of control that the occupant has over the vehicle, or it could adjust the vehicle's handling or stability to improve the occupant's comfort or safety.

Accordingly, it should be understood that the autonomous vehicle feedback system 100 described herein is exemplary in nature. As indicated above, other sensors, input methods, and vehicle operations may be utilized to create a system that effectively monitors the occupant's emotional responses and adjusts the vehicle's operations to improve the comfort, safety, and efficiency of the vehicle without departing from the present disclosure.

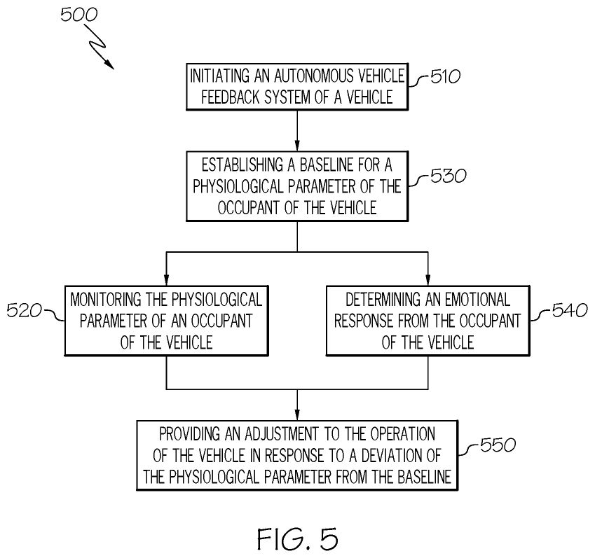

Turning now to FIG. 5, an illustrative method 500 of operating a vehicle is depicted. For illustrative purposes, the method 500 of operating a vehicle may be described in reference to the feedback system 100 that has been described herein with reference to FIGS. 1-4 (e.g., a system that measures the moisture of an occupant's skin to determine a physiological parameter of the occupant). However, it should be understood that similar methods may be implemented with feedback systems that utilize other means for measuring a physiological parameter without departing from the scope of the present disclosure.

As depicted at block 510, the method depicted in FIG. 5 may initially involve an occupant of a vehicle placing their hands on a steering wheel of the vehicle to initiate an autonomous vehicle feedback system. In these embodiments, the autonomous vehicle feedback system may include a camera and a physiological data detection assembly, which may be used to gauge an emotional response, and the intensity of said emotional response, of the occupant as a result of changes to at least one of a plurality of vehicle operations during an operational cycle of the vehicle.

In these embodiments, the physiological data detection assembly may include at least one sensor, which may be embedded in the steering wheel of the vehicle. In these embodiments, the at least one sensor may be configured to measure a physiological parameter of the occupant of the vehicle. Once the at least one sensor is able to read the physiological parameter of the occupant, the method may move to block 520, which may involve establishing a baseline for the physiological parameter of the occupant of the vehicle based on feedback from the sensor.

Once the baseline is established, the method may further involve monitoring the physiological parameter of the occupant of the vehicle, as shown at block 530. As has been described in detail herein, the physiological parameter may be measured via the at least one sensor through contact between the hands of the occupant of the vehicle and the steering wheel. The at least one sensor may continue to monitor the physiological parameter of the occupant of the vehicle in real-time, and may adjust at least one of the plurality of vehicle operations when the physiological parameter deviates from the baseline.

In particular embodiments, and as has been described herein, the physiological parameter of the occupant of the vehicle that is monitored may be a moisture level present on the hands of the occupant of the vehicle. In these embodiments, the physiological data detection assembly may further include a light diffuser embedded in the steering wheel, which may scatter light that passes through the diffuser in order to generate a refractive light index. The light index may then be measured by the at least one sensor to determine the moisture level of the hands of the occupant of the vehicle, as the moisture level may impact the refractive light index. Accordingly, in the specific embodiments described herein, the method may further involve passing light through a light diffuser embedded within the steering wheel and monitoring the refractive index of the light passing through the light diffuser using the at least one sensor. It should be further understood that, in these embodiments, the at least one sensor may be an optical sensor for measuring the refractive light index generated by the light diffuser.

Referring still to FIG. 5, the method may further involve capturing facial images of the occupant using the camera in order to determine an emotional response from the occupant of the vehicle related to the operation of the vehicle, as shown at block 540. For example, facial recognition software may be used to determine if the occupant feels happy, upset, or neutral towards the current operation of the vehicle.

Furthermore, it should be understood that the method steps of blocks 530 and 540 may be conducted simultaneously. That is to say, the method may involve simultaneously utilizing the camera to determine an emotional response from the occupant of the vehicle and measuring the physiological parameter of the occupant to identify deviations from the baseline and determine the magnitude of the emotional response. For example, in some embodiments, the camera may determine that the occupant is exhibiting facial indications that they are unhappy with the operation of the vehicle. In these embodiments, the deviation of the physiological parameter from the baseline that is measured by the at least one sensor may indicate the intensity of the emotional response experienced by the occupant. For example, as described herein, measurements of the physiological parameter that significantly deviate from the baseline may indicate an intensely negative emotional response by the occupant. In contrast, measurements of the physiological parameter that marginally deviate from the baseline may correspond to a relatively minor emotional response by the occupant.

Referring still to FIG. 5, the method may further involve adjusting the operation of the vehicle in response to the deviation of the physiological parameter from the baseline, as is depicted at block 550. In some embodiments, adjustments of the physiological parameter may only be implemented when deviation of the physiological parameter from the baseline meets or exceeds a predetermined threshold. However, in other embodiments, the method may involve adjusting, in real-time, operation of the vehicle in response to any deviation of the physiological parameter from the baseline, such that the adjustment of the at least one of the plurality of vehicle operations is proportional to the deviation of the physiological parameter from the baseline. For example, in these embodiments, greater deviations of the physiological parameter from the baseline may correspond to more drastic adjustments to the operation of the vehicle.

From the above, it is to be appreciated that defined herein are autonomous vehicle feedback systems and methods for operating an autonomous vehicle. Specifically, the autonomous vehicle feedback systems disclosed herein may include at least one sensor embedded in a steering wheel of the autonomous vehicle, and a processor electrically coupled to the sensor. The processor may establish a baseline for a physiological parameter of an occupant of the vehicle based on feedback from the at least one sensor, and may adjust at least one of a plurality of vehicle operations when the physiological parameter deviates from the baseline, such that the adjustment of the at least one of the plurality of vehicle operations is proportional to the deviation of the physiological parameter from the baseline. Furthermore, the autonomous vehicle feedback system may include a camera positioned within the autonomous vehicle, with the camera being configured to determine an emotional response of an occupant of the vehicle to changes in the at least one of the plurality of vehicle operations. In these embodiments, the camera may indicate the occupant's emotional response (e.g., happy, sad, neutral) to changes in the at least one of the plurality of vehicle operations, while the deviation of the physiological parameter from the baseline may correspond to the intensity of the emotional response captured by the camera.

It should now be understood that embodiments of the present disclosure are directed to autonomous vehicle feedback systems that monitor a physiological parameter of an occupant of the vehicle and adjust at least one of a plurality of vehicle operations in response and in proportion to deviations of the physiological parameter compared to a baseline. Such autonomous vehicle feedback systems may improve the safety and comfort of an occupant in an autonomous vehicle by providing a more personalized and responsive method of adjusting vehicle operation in modern vehicles.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. An autonomous vehicle feedback system comprising:
at least one sensor embedded in an interior surface of a vehicle; and
a processor electrically coupled to the at least one sensor;
wherein the processor establishes a baseline for a physiological parameter of an occupant of the vehicle based on feedback from the at least one sensor, and provides an adjustment to at least one of a plurality of vehicle operations when a deviation of the physiological parameter compared to the baseline, such that the adjustment of the at least one of the plurality of vehicle operations is proportional to the deviation of the physiological parameter from the baseline.

2. The autonomous vehicle feedback system of claim 1, wherein the physiological parameter of the occupant is a moisture level.

3. The autonomous vehicle feedback system of claim 1, wherein the at least one of the plurality of vehicle operations include one or more of a vehicle speed, route, driving mode, temperature, airflow, audio content, or message display.

4. The autonomous vehicle feedback system of claim 1, further comprising a camera positioned within the vehicle, the camera including facial recognition software used to determine an emotional response of the occupant of the vehicle, wherein the emotional response determined by the camera and the at least one sensor are used to determine the deviation of the physiological parameter of the occupant of the vehicle.

5. The autonomous vehicle feedback system of claim 1, further comprising a light diffuser embedded into the steering wheel.

6. The autonomous vehicle feedback system of claim 5, wherein the at least one sensor is an optical sensor.

7. The autonomous vehicle feedback system of claim 6, wherein the at least one sensor monitors a refractive light index passing through the light diffuser.

8. The autonomous vehicle feedback system of claim 7, wherein the optical sensor provides data representing a moisture level associated with the occupant to the processor for establishing the baseline for the physiological parameter.

9. The autonomous vehicle feedback system of claim 1, further including a graphical user interface that communicates data representing the physiological parameter to the occupant of the vehicle.

10. The autonomous vehicle feedback system of claim 9, wherein the graphical user interface further displays advertisements to the occupant of the vehicle, and the advertisements displayed by the graphical user interface are determined based on the deviation of the physiological parameter from the baseline.

11. The autonomous vehicle feedback system of claim 9, wherein the graphical user interface further includes manual inputs that allow the occupant of the vehicle to manually control the at least one of the plurality of vehicle operations.

12. An autonomous vehicle feedback system comprising:
a light diffuser embedded in an interior surface of a vehicle;
at least one optical sensor embedded in the interior surface of the vehicle; and
a processor electrically coupled to the at least one optical sensor;
wherein the optical sensor monitors a refractive light index associated with the light diffuser and the processor establishes a baseline moisture level of an occupant of the vehicle based on the change in the refractive index measured by the at least one optical sensor, and the processor provides an adjustment to at least one of a plurality of vehicle operations when a deviation from the baseline moisture level occurs, such that the adjustment of the at least one of the plurality of vehicle operations is proportional to the deviation of from the baseline moisture level.

13. The autonomous vehicle feedback system of claim 12, wherein the plurality of vehicle operations include one or more of a vehicle speed, route, driving mode, temperature, airflow, audio content, or message display.

14. A method of operating an autonomous vehicle comprising:
monitoring a physiological parameter of an occupant of a vehicle using at least one sensor embedded in an interior surface of the vehicle;
establishing a baseline for the physiological parameter of the occupant of the vehicle based on feedback from the at least one sensor; and
providing an adjustment to at least one of a plurality of vehicle operations when a deviation of the physiological parameter from the baseline is measured by the at least one sensor, such that the adjustment of the at least one of the plurality of vehicle operations is proportional to the deviation of the physiological parameter from the baseline.

15. The method of claim 14, wherein the at least one sensor is an optical sensor.

16. The method of claim 15, wherein the step of monitoring the physiological parameter further comprises:
passing light through a light diffuser embedded in the interior surface of the vehicle; and
monitoring a refractive light index passing through the light diffuser using the optical sensor.

17. The method of claim 16, wherein the step of establishing the baseline for the physiological parameter further comprises:
reading the refractive light index passing through the light diffuser to determine the baseline for the physiological parameter.

18. The method of claim 14, wherein the physiological parameter is a moisture level.

19. The method of claim 14, wherein the at least one of the plurality of vehicle operations include one or more of a vehicle speed, route, driving mode, temperature, airflow, audio content, or message display.

20. The method of claim 19, further comprising:
displaying an advertisement to the occupant of the vehicle;
monitoring the physiological parameter of the occupant in response to the advertisement; and
adjusting the advertisement displayed to the occupant based on the deviation of the physiological parameter from the baseline.
